(19) United States
(12) Patent Application Publication
(10) Pub. No.: US 2007/0151792 A1
(43) Pub. Date: Jul. 5, 2007

(54) Device for mounting a pedal lever

(76) Inventors: Andree Burgstaler, Dielingen (DE); Jan Dutz, Damme (DE); Wolfgang Meyer, Osnabruck (DE); Silke Hulsmann, Ankum (DE)

Correspondence Address: MCGLEW & TUTTLE, PC, P.O. BOX 9227, SCARBOROUGH STATION, SCARBOROUGH, NY, 10510-9227, US

(21) Appl. No.: 10/595,787

(22) PCT Filed: Nov. 18, 2004
(86) PCT No.: PCT/DE04/02534

§ 371 Date: May 11, 2006

(30) Foreign Application Priority Data
Nov. 20, 2003 (DE) 103 54 378.3

(51) Int. Cl. B60T 7/22; G05G 1/14

(52) U.S. Cl. 180/276; 74/512

(57) ABSTRACT

A pedal lever (2) of a motor vehicle is mounted in a pivotingly movable manner about a pivot axis (5), which is arranged at a bearing block (4). The pivot axis (5) is designed as a bearing bolt (6). An abutment (8) is arranged at a spaced location from the bearing block (4) as well as a tear-off member (9), which is designed as a two-armed lever (10) and is arranged between the bearing block (4) and the abutment (8). The tear-off member (9) brings about the shearing off of the pivot axis (5) of the pedal lever (2) as a consequence of the action of an external force caused by a crash due to a relative motion between the tear-off member (9) and the bearing block (4) while a shearing force is applied. The tear-off member (9) is supported at the bearing block (4) at a spaced location from the pivot axis (5) of the pedal lever (2).

### CROSS REFERENCE TO RELATED APPLICATIONS

This application is a United States National Phase application of International Application PCT/DE 2004/002534 and claims the benefit of priority under 35 U.S.C. § 119 of German Patent Application DE 103 54 378.3 filed Nov. 20, 2003, the entire contents of which are incorporated herein by reference.

### FIELD OF THE INVENTION

The present invention pertains to a device for mounting a pedal lever of a motor vehicle, which is mounted on a bearing block in a pivotingly movable manner about a pivot axis designed as a bearing bolt. Furthermore, the device comprises an abutment located at a spaced location from the bearing block as well as a tear-off member, which is designed as a two-armed lever and is arranged between the bearing block and the abutment.

### BACKGROUND OF THE INVENTION

The increasing requirements imposed on motor vehicles concerning increasing safety are manifest in numerous systems. A known risk for accidents that occurs in connection with pedal fastening mechanisms is that deformation of the engine compartment directly or indirectly affects the pedal levers and these are moved into the interior of the leg room of the motor vehicle. The risks associated herewith for the driver of the motor vehicle can be seen in serious injuries of the lower extremities, which may be caused by jamming between the pedal levers. Besides a restrictedly guided pivoting of the pedal levers from the danger zone, devices are known with which the pedal levers are separated from the bearing block in case of displacement of the bearing block in the direction of the interior space of the vehicle in order to thus avoid hazards to the driver of the motor vehicle. The introduction of force caused by the accident with displacement of the connection of the pedal lever, which is associated with it, is used for the separation operation.

A device for mounting a pedal lever, in which the pedal lever is separated from the bearing block in two steps by means of a tear-off member arranged between a bearing block and an abutment, is known from EP 1 059 208 A2 (U.S. Pat. No. 6,354,171). The tear-off member is mounted at the bearing block in a pivotingly movable manner about the pivot axis of the pedal lever and weakens this [the bearing block] in case of displacement of the bearing block in a first step due to the fact that by means of lugs arranged at the bearing block, the bearing block is weakened by the breaking out of the lugs and of parts of material surrounding the said lugs. When the displacement of the bearing block progresses, the entire area of the bearing block that is located around the pivot axis of the pedal lever is separated from the bearing block together with the pedal lever and the tear-off member. Besides the two-step separation and the time delay of the separation of the pedal lever, which is associated with it, and as a result of which the driver of the motor vehicle may be jeopardized, the fact that large areas of the bearing block are destroyed is to be considered to be especially disadvantageous. On the one hand, stronger forces are necessary for this, and the component falling into the leg room is of a considerable size, as a result of which hazard to the driver of the motor vehicle cannot be ruled out. In addition, the bearing block breaks in an essentially uncontrolled manner in the second step. The device per se has, furthermore, a relatively complicated design.

### SUMMARY OF THE INVENTION

The object of the present invention is to provide a device for mounting a pedal lever, which leads to a further reduction of the hazard and the degree of severity of the injuries to the driver of the motor vehicle in case of an accident and has, furthermore, a simplified design.

The object is accomplished for a device of this type for mounting a pedal lever with a pedal lever mounted in a pivotingly movable manner about a pivot axis that is arranged at a bearing block and is designed as a bearing bolt. An abutment is located at a spaced location from the bearing block. A tear-off member is provided, designed as a two-armed lever. This tear-off member is arranged between the bearing block and the abutment. The tear-off member brings about the shearing off of the bearing bolt of the pedal lever as a consequence of the action of an external force caused by a crash due to a relative motion between the tear-off member and the bearing block while a shearing force is applied. The tear-off member is supported at the bearing block at a spaced location from the pivot axis of the pedal lever of the bearing block.

It is proposed according to the present invention for a device for mounting a pedal lever to mount a tear-off member at the bearing block in a pivotingly movable manner at a spaced location from the pivot axis of the pedal lever. Due to a relative motion caused by the action of an external force as a consequence of a crash between the tear-off member and the bearing block, the tear-off member causes the pivot axis of the pedal lever to be shorn off while a shearing force is applied. Due to the separate mounting of the pedal lever and the tear-off member, both the pedal lever and the tear-off member enter the leg room after the shearing off as separate components, which are, on the whole, rather small compared to the state of the art, as a result of which the risk of injury to the driver of the motor vehicle as a consequence of a crash is reduced. The tear-off member may possibly become jammed after the shearing off between the abutment and the pedal block, so that the tear-off member does not enter the leg room at all. The risk of injury to the driver of the motor vehicle is thus further reduced.

The tear-off member designed as a two-armed lever is in contact at one end with a stationary abutment and at the other end with the pivot axis of the pedal lever. Between these two ends, the tear-off member is supported at an arc-shaped contour of the bearing block, which contour forms the pivotingly movable mounting point of the tear-off member. In a preferred embodiment, the contour is convex and arc-shaped at the bearing block. The tear-off member has a complementary concave vault for a defined pivoting motion. A simplified mechanical design with few additional elements as well as few and very simply design changes is thus obtained, as a result of which a cost-effective crash safety system can be embodied.

The fact that the tear-off member can be designed especially favorably as a deep-drawn profiled part, which can be manufactured in an especially simple and cost-effective manner and performs all the necessary functions, contributes to this, among other things. Thus, the abutment may already be in contact in a concavity of the tear-off member in a positive-locking manner in the non-use state, so that reliable function is always guaranteed. On the whole, the crash safety system is thus also insensitive to component tolerances.

The tear-off member is advantageously held at the bearing block by means of a securing means, so that the device for mounting a pedal lever can be manufactured especially favorably as a preassembled module. The costs can thus be reduced further.

Other measures improving the present invention are described in the subclaims or will be described in greater detail below together with the description of a preferred exemplary embodiment of the present invention on the basis of the figures.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 is a perspective view of the device according to the present invention;

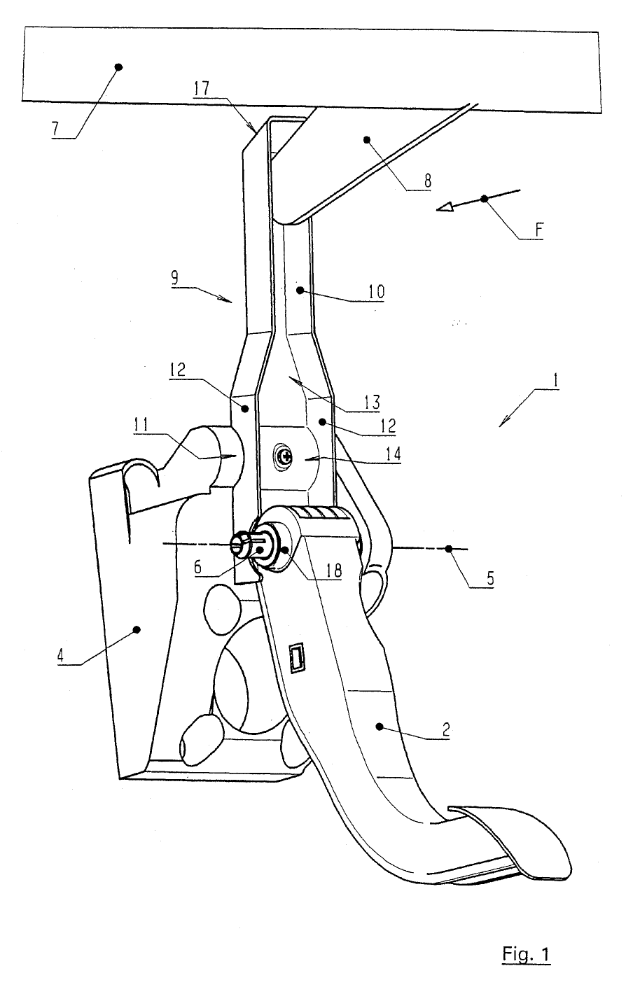

FIG. 2 is a lateral, partially cut-away view of the device according to the present invention; and

FIG. 3 is a detail view of the bearing bolt of the pivot axis.

### DESCRIPTION OF THE PREFERRED EMBODIMENTS

Referring to the drawings in particular, the device 1 for mounting a pedal lever 2 of a motor vehicle has a bearing block 4 fixed to the body by means of a screw connection 3, on which bearing block the pedal lever 2 is mounted in a pivotingly movable manner about a pivot axis 5. The pivot axis 5 is designed as a bearing bolt 6, and lateral round projecting parts 18 made in one piece are arranged around the opening through which the bearing bolt exits at the pedal lever 2 on both sides. A vehicle crossrail 7, which is arranged at right angles to the direction of travel F and is fastened to the body independently from the bearing block 4, is arranged above and at a spaced location from the bearing block 4. Essentially wedge-shaped abutments 8, which are sloped with their tips in the direction of travel F, are arranged at the crossrail of the vehicle. The orientation and the shape of the abutments is not limited to the exemplary embodiment being shown and it may be selected to be different from that being shown depending on the arrangement of the bearing block 4 and the crossrail 7 of the vehicle.

A tear-off member 9, which is designed as a two-armed lever 10 and is supported at the bearing block 4 via the support 11, is arranged between the bearing block 4 and the abutment 8. The two-armed lever 9 is designed as a deep-drawn profiled part with two lateral legs 12, which laterally define a recess 13, as well as with a concave vault 14. The concave vault 14 is in contact with a projecting part 15 made in one piece with the bearing block 4, the projecting part made in one piece having a contour 16 arched in a circular convex shape. The convex contour 16 and the concave arch 14 are coordinated with one another. Additional securing elements, not shown, may be used to hold the tear-off member 9 at the bearing block 4, so that the tear-off member 9 is associated with the bearing block 4 and can be manufactured as a preassembled module.

In the mounted state, the abutment 8 meshes with the recess 13 in the upper end area of the two-armed lever 10, so that the lateral legs 12 as well as an upper limitation 17 surround the abutment in a positive-locking manner. The width of the recess 13 is adapted to the width of the abutment 8 in this area. In the lower area, the two-armed lever 10 with its lateral legs 12 extends around the pedal lever 2. The width of the recess 13 is adapted to the width of the pedal lever 2 in this area. The lateral legs 12 have another recess 21 in the area of the bearing bolt 6, so that the contour of the leg 12 is coordinated with the shape of the lateral projections 17 made in one piece.

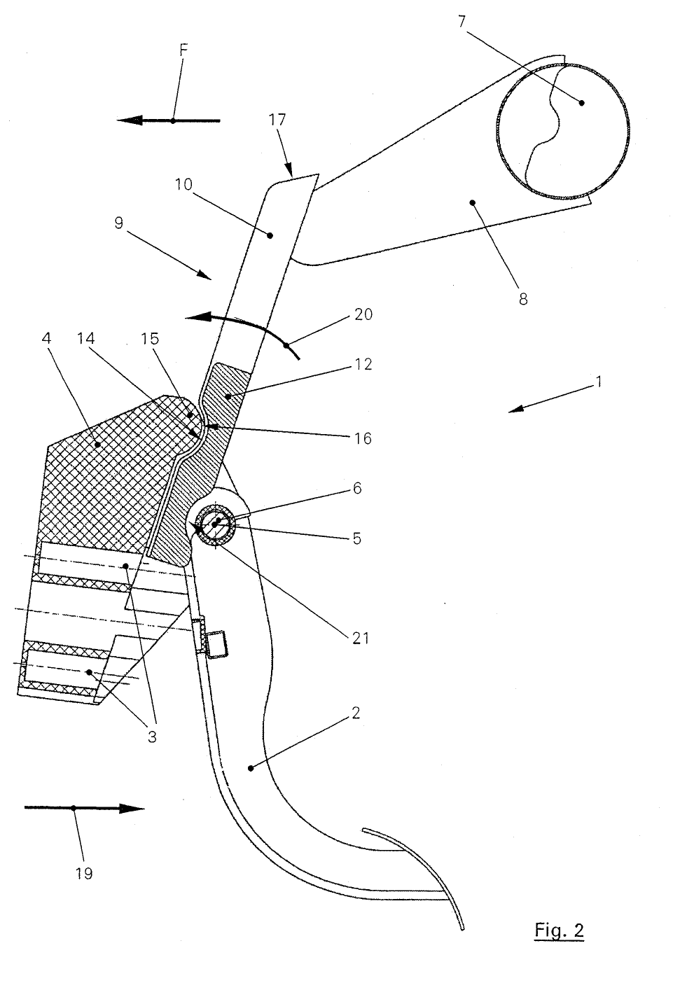

In case of an accident, the engine compartment undergoes deformation and the bearing block 4 with the pedal lever 2 articulated thereto is displaced in the direction of arrow 19 in the direction of the interior space of the vehicle (FIG. 2). The vehicle crossrail 7 is considered to continue to be stationary, so that a relative displacement takes place between the bearing block 4 and the vehicle crossrail 7.

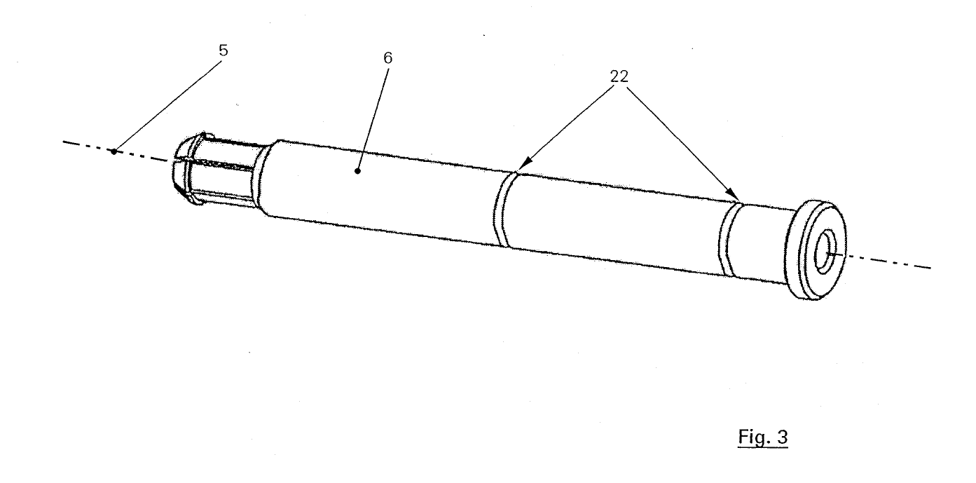

The tear-off member 9 in the embodiment of the two-armed lever 10 is held by the abutment at its upper end, while the tear-off member 9 is pressed in the direction of the interior space of the vehicle in the area of the projection 15 of the bearing block 4. The two-armed lever 10 is thus set into a rotary motion according to arrow 20 (FIG. 2), and the two-armed lever 10 slides along on the arc-shaped contour 16 of the projection 15 at the bearing block 4 about a virtual fulcrum point within the bearing block 4. The two lateral legs 12 of the two-armed lever provided as the tear-off member 9 come into contact with the lateral projections 18 made in one piece of the pedal lever 2 in the area of their recess 21, and a force is transmitted to the bearing bolt 6. As soon as the force exerted by the two-armed lever 10 on the bearing bolt 6 exceeds a certain value, the bearing bolt 6, which forms the pivot axis 5, is shorn off and releases the pedal lever 2, so that the latter falls freely into the leg room and cannot jeopardize the driver of the vehicle any longer. At least one predetermined breaking points 22 is provided at the bearing bolt 6 for the defined shearing off of the bearing bolt 6. However, as is shown in the exemplary embodiment according to FIG. 3, two predetermined breaking points 22 are provided for satisfactory shearing off.

Due to the tear-off member 9 being designed as a deep-drawn two-armed lever 10 with two lateral legs 12, optimized transmission of the force is made, furthermore, possible. The force necessary for shearing off the bearing bolt 6 is introduced via the large-area contour 16 at the bearing block 4. By contrast, the force is transmitted to the bearing bolt 6 via the relatively narrow lateral leg 12 of the two-armed lever 10, as a result of which the forces can be introduced in a concentrated manner in the area of the predetermined breaking points 22. In addition, the force for shearing off the bearing bolt 6 can be affected by the optimized selection of the levers between the support of the lever 10 at the contour 16 of the 4 and the abutment 8 as well as between the support of the lever 10 on the contour 16 of the 4 and the recess 21, which comes to lie on the lateral projections 18 made in one piece of the pedal lever 2.

The tear-off member 9 can be held at the 4 via a securing member, so that this can be held in a position that does not jeopardize the driver of the motor vehicle even after the pedal lever 2 has been separated. As an alternative, the tear-off member 9 may also be detached from the bearing block 4 and fall into the leg room. The hazard to the driver of the motor vehicle is likewise reduced in this case, because only a relatively small additional component is located in the leg room. To reduce the possible hazard for the driver of the motor vehicle due to the components located loosely in the leg room, provisions may be made for the pedal lever 2 as well as the tear-off member 9 to be held by a securing element, for example, a cable, in order to prevent these components from being able to be moved away from the bearing block 4 over a defined distance.

The device being presented here for mounting a pedal lever 2 with the integrated safety device is characterized, besides by the simple mechanical design with a small number of additional elements of a simple design, by the fact that only the bearing bolt 6 is destroyed in case of a crash. All other components, especially the bearing block 4, the tear-off member 9 and the pedal lever 2, are extensively preserved and can be reused, if necessary, when the vehicle is repaired.

Due to the few mechanical components, this mounting device 1 as a whole is relatively insensitive to component tolerances. The cumulative tolerances are not affected by the crash system especially in the area in which the force of the pedal lever 2 is transmitted to an actuating means, not shown, which is connected to the pedal lever, for example, a brake device. Since, furthermore, no moving components are present, the mounting device also does not tend to rattle.

Due to the tear-off member 9 being held at the bearing block, the mounting device with the crash system may be manufactured and shipped as a ready-to-install module. All other pedal levers on a pedal mechanism may likewise be equipped with the crash safety system being presented here, as a result of which standardization can be achieved in the system.

Considerable weight savings can be achieved by manufacturing especially the bearing block 4 and the pedal lever 2 of plastic. At least the tear-off member 9 advantageously consists of a metallic material for reliable force transmission.

While a specific embodiment of the invention has been shown and described in detail to illustrate the application of the principles of the invention, it will be understood that the invention may be embodied otherwise without departing from such principles.

1. A device for mounting a pedal lever of a motor vehicle, the device comprising:
a bearing block;
a pedal lever mounted in a pivotingly movable manner about a pivot axis that is arranged at said bearing block and is designed as a bearing bolt
an abutment located at a spaced location from the bearing block and
a tear-off member comprising a two-armed lever, arranged between said bearing block and said abutment, said tear-off member for shearing off the bearing bolt of the pedal lever as a consequence of the action of an external force caused by a crash due to a relative motion between said tear-off member and said bearing block while a shearing force is applied, said tear-off member being supported at said bearing block at a spaced location from said pivot axis of said pedal lever of the bearing block.

2. A device in accordance with claim 1, wherein the support of the tear-off member comprises a pivotingly movable support.

3. A device in accordance with claim 1, wherein the pedal lever comprises a pedal.

4. A device in accordance with claim 1, wherein the tear-off member is in contact with an arc-shaped contour of the bearing block in a pivotingly movable manner.

5. A device in accordance with claim 4, wherein the contour on the bearing block has an arc-shaped design with a convex arch.

6. A device in accordance with claim 5, wherein the tear-off member has a concave arch that is complementary to the contour of the bearing block.

7. A device in accordance with claim 1, wherein the tear-off member is designed as a profiled part with two lateral legs.

8. A device in accordance with claim 7, wherein the tear-off member is designed as a deep-drawn part.

9. A device in accordance with claim 7, wherein the lateral legs of the profiled part are in contact with the pedal lever in a positive-locking manner in the immediate vicinity of the pivot axis of the pedal lever.

10. A device in accordance with claim 1, wherein the tear-off member designed as a profiled part is in contact with the abutment in a positive-locking manner.

11. A device in accordance with claim 10, wherein the tear-off member is in contact with the abutment such that the abutment dips into a recess between the lateral legs of the tear-off member and is surrounded by the legs in a positive-locking manner.

12. A device in accordance with claim 1, wherein the abutment is arranged on a stationary vehicle crossrail.

13. A device in accordance with claim 1, wherein the bearing bolt has at least one said predetermined breaking point.

14. A device in accordance with claim 1, wherein the tear-off member has a securing means for mounting on the bearing block.

15. A device in accordance with claim 1, wherein the device for mounting the pedal lever of a motor vehicle is designed as a preassembled module with the tear-off member.

16. A pedal lever mounting arrangement comprising:
a bearing block;
a bearing bolt supported by said bearing block to define a pivot axis;
a pedal lever mounted in a pivotingly movable manner to said a bearing bolt;
a vehicle abutment part located at a spaced location from said bearing block; and
a tear-off member arranged between said bearing block and said abutment for shearing said bearing bolt as a consequence of the action of an external force causing a relative motion between said tear-off member and said bearing block, said tear-off member being supported at said bearing block at a spaced location from said pivot axis.

17. A device in accordance with claim 16, wherein said tear-off member is supported pivotingly movably.

18. A device in accordance with claim 17 wherein the tear-off member is in contact with an arc-shaped contour of said bearing block in a pivotingly movable manner.

19. A device in accordance with claim 18, wherein a contour of said bearing block has an arc-shape with a convex arch.

20. A device in accordance with claim 19, wherein said tear-off member has a concave arch that is complementary to the contour of said bearing block.
